(19) United States
(12) Patent Application Publication
(10) Pub. No.: US 2018/0076750 A1
(43) Pub. Date: Mar. 15, 2018

(54) CONTROLLER FOR PERMANENT MAGNET SYNCHRONOUS MOTOR, CONTROL METHOD, AND IMAGE FORMING APPARATUS

(71) Applicant: KONICA MINOLTA, INC., Tokyo (JP)

(72) Inventors: Kazumichi YOSHIDA, Toyokawa-shi (JP); Katsuhide SAKAI, Toyokawa-shi (JP); Tomonobu TAMURA, Toyokawa-shi (JP); Hitoshi ASANO, Toyokawa-shi (JP); Harumitsu FUJIMORI, Tokyo (JP)

(73) Assignee: KONICA MINOLTA, INC., Tokyo (JP)

(21) Appl. No.: 15/682,652

(22) Filed: Aug. 22, 2017

(30) Foreign Application Priority Data
Sep. 12, 2016 (JP) 2016-177319

(51) Int. Cl. H02P 21/18

(52) U.S. Cl. CPC H02P 21/18; H02P 2207/05; H02P 2203/11

(57) ABSTRACT

A controller for a permanent magnet synchronous motor having a rotor using a permanent magnet includes a drive portion configured to apply a current to a winding to drive the rotor; an estimating portion configured to estimate a position of magnetic pole of the rotor; and a control unit configured to control the drive portion to cause the rotating magnetic field based on the estimated position of magnetic pole and to control the drive portion to stop the rotor in response to a stop command inputted. The control unit controls, as the control to stop the rotor, the drive portion to determine a current for generating a magnetic field vector which draws the position of magnetic pole of the rotor to a stop position to stop the rotor based on a latest estimated position of magnetic pole, and to keep applying the current determined to the winding.

Japanese Patent application No. 2016-177319 filed on Sep. 12, 2016, including description, claims, drawings, and abstract of the entire disclosure is incorporated herein by reference in its entirety.

### BACKGROUND

### 1. Technological Field

The present invention relates to a controller for permanent magnet synchronous motor, a control method, and an image forming apparatus.

### 2. Description of the Related Art

Permanent Magnet Synchronous Motors (PMSM) generally have a stator with windings and a rotor using a permanent magnet. In such permanent magnet synchronous motors, an alternating current is applied to the windings to cause a rotating magnetic field, which rotates the rotor synchronously therewith. The use of a vector control in which an alternating current is used as a vector component of a d-q coordinate system enables the rotor to rotate smoothly with a high efficiency.

Recent years have seen the widespread use of sensorless permanent magnet synchronous motors. Such a sensorless permanent magnet synchronous motor has no encoder and no magnetic sensor for detecting a position of magnetic poles. For this reason, in the vector control on such a sensorless permanent magnet synchronous motor, a method is used in which a position of magnetic poles of a rotor and a rotational speed thereof are estimated based on a current or voltage of the windings. However, a control for causing a predetermined magnetic field without estimating a position of magnetic poles and a rotational speed of a rotor is made for the case where the rotational speed is small, for example, where the rotor starts to rotate or stops. This is because a position of magnetic poles and a rotational speed cannot be estimated at a predetermined degree of accuracy.

Control methods for stopping a rotor includes: a short brake control in which the supply of current is cut off and current paths of a drive circuit are connected to each other to obtain energy from a permanent magnet synchronous motor; and a free running control in which the supply of current is cut off only.

However, the use of such control methods to stop a rotor poses a problem that the rotor stops at different positions due to variations in load or inertial force. For this reason, when the rotor stops and then restarts rotating, it is necessary to estimate a position of magnetic poles of the stopping rotor in a certain manner, which delays the restart of the rotation by length of time necessary for the estimation. Further, the sensorless permanent magnet synchronous motor cannot be used for application in which the load should be positioned at a predetermined stop position at the stop of the rotor.

As a conventional technology for stopping a rotor of a sensorless permanent magnet synchronous motor at a desired position, there has been proposed a technology described in Japanese Patent No. 5487105 which relates to control on a linear synchronous motor. According to the technology, a d-axis electrical angle is produced which changes continuously in response to a position command continuously given from an upper controller, and a current passing through armatures is so controlled that a current passes through the d-axis armature and no current passes through the q-axis armature.

The technology described in Japanese Patent No. 5487105 is to drive the linear synchronous motor which has a movable element travelling in a straight line and a stator extending along the entire length of the travel range of the movable element. The technology is provided on the premise that a position command is given continuously to designate the individual positions of the travelling movable element.

This involves, therefore, continuously giving position commands to designate positions of the movable element, which makes the control therefor complex.

Where a rotor of a permanent magnet synchronous motor is stopped, the stop position thereof is preferably settable minutely. More options for setting the stop positions are better. To be specific, more positions such as 360 positions in increments of 1 degree is better than less positions such as 6 positions in increments of 60 degrees. Stepless options are further better. The arrangement in which the stop positions are settable minutely or in a stepless manner makes it possible to stop the rotor at desired positions for a minimum necessary time. Further, where the load is positioned at the stop of the rotor, the arrangement enables positioning at desired positions with a high degree of accuracy.

### SUMMARY

The present invention has been achieved in light of such a problem, and therefore, an object of an embodiment of the present invention is to provide a controller and control method which stop a rotor of a permanent magnet synchronous motor at a desired position.

To achieve at least one of the abovementioned objects, according to an aspect of the present invention, a controller reflecting one aspect of the present invention is a controller for a permanent magnet synchronous motor having a rotor using a permanent magnet, the rotor rotating by a rotating magnetic field caused by a current flowing through a winding. The controller includes a drive portion configured to apply a current to the winding to drive the rotor; an estimating portion configured to estimate a position of magnetic pole of the rotor based on the current flowing through the winding; and a control unit configured to control the drive portion to cause the rotating magnetic field based on the estimated position of magnetic pole and to control the drive portion to stop the rotor in response to a stop command inputted; wherein the control unit controls, as the control to stop the rotor, the drive portion to determine a current for generating a magnetic field vector which draws the position of magnetic pole of the rotor to a stop position to stop the rotor based on a latest estimated position of magnetic pole, and to keep applying the current determined to the winding.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing an outline of the structure of an image forming apparatus having a motor controller according to an embodiment of the present invention.

FIG. 2 is a diagram schematically showing an example of the structure of a brushless motor.

FIG. 3 is a diagram showing an example of a d-q-axis model of a brushless motor.

FIG. 4 is a diagram showing an example of the functional configuration of a motor controller.

FIG. 5 is a diagram showing an example of the configuration of a motor drive portion and a current detector.

FIG. 6 is a diagram showing an example of a drive sequence at the time of the stop.

FIGS. 7A-7C are diagrams showing examples as to how to set a magnetic field vector for stopping a rotor.

FIGS. 8A and 8B are diagrams showing examples of current vectors corresponding to magnetic field vectors.

FIG. 9 is a diagram showing examples of a state of a rotor and a magnetic field vector before the rotor stops by fixed excitation control.

FIG. 10 is a diagram showing an example of the configuration of a speed control unit, a storage portion, a current control unit, and an output coordinate transformation portion of a motor controller.

FIG. 11 is a diagram showing another example of a drive sequence at the time of the stop.

FIG. 12 is a diagram showing an example of the flow of processing for stopping rotation in a motor controller.

FIG. 13 is a diagram showing another example of the flow of processing for stopping rotation in a motor controller.

FIG. 14 is a diagram showing an example of the flow of processing for fixed excitation control.

### DETAILED DESCRIPTION OF EMBODIMENTS

Hereinafter, one or more embodiments of the present invention will be described with reference to the drawings. However, the scope of the invention is not limited to the disclosed embodiments.

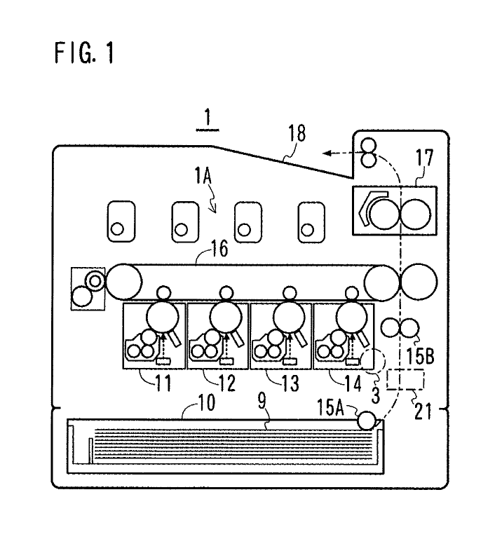

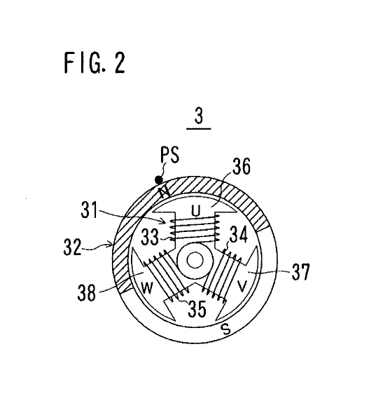

FIG. 1 shows an outline of the structure of an image forming apparatus 1 having a motor controller 21 according to an embodiment of the present invention. FIG. 2 schematically shows an example of the structure of a brushless motor 3.

Referring to FIG. 1, the image forming apparatus 1 is a color printer provided with an electrophotographic printer engine 1A. The printer engine 1A has four imaging stations 11, 12, 13, 14 to form, in parallel, a toner image of four colors of yellow (Y), magenta (M), cyan (C), and black (K). Each of the imaging stations 11, 12, 13, and 14 has a tubular photoconductor, an electrostatic charger, a developing unit, a cleaner, a light source for exposure, and so on.

The toner image of four colors is primarily transferred to the intermediate transfer belt 16, and then secondarily transferred onto paper 9 which has been sent out from a paper cassette 10 by a paper feed roller 15A, has passed through registration rollers 15B, and has been conveyed. After the secondary transfer, the paper 9 passes through a fixing unit 17 and then to be delivered to a paper output tray 18 which is provided in an upper part of the image forming apparatus 1. While the paper 9 passes through the fixing unit 17, the toner image is fixed onto the paper 9 by application of heat and pressure.

The image forming apparatus 1 uses a plurality of brushless motors including the brushless motor 3 as drive sources to rotate rotating members such as the fixing unit 17, the intermediate transfer belt 16, the paper feed roller 15A, the registration rollers 15B, the photoconductor, and a roller for the developing unit. Stated differently, the printer engine 1A forms an image onto the paper 9 while using the rotating members of which rotation is driven by the brushless motors to feed the paper 9.

The brushless motor 3 is disposed, for example, in the vicinity of the imaging station 14 to drive the rotation of the registration rollers 15B. The brushless motor 3 is controlled by the motor controller 21.

Referring to FIG. 2, the brushless motor 3 is a sensorless Permanent Magnet Synchronous Motor (PMSM). The brushless motor 3 has a stator 31 for causing a rotating magnetic field and a rotor 32 using a permanent magnet. The stator 31 has a U-phase core 36, a V-phase core 37, and a W-phase core 38 that are located at electrical angle of 120° intervals from one another and three windings (coils) 33, 34, and 35 that are provided in the form of Y-connection. A 3-phase alternating current of U-phase, V-phase, and W-phase is applied to the windings 33-35 to excite the cores 36, 37, and 38 in turn, so that a rotating magnetic field is caused. The rotor 32 rotates in synchronism with the rotating magnetic field.

FIG. 2 shows an example in which the number of magnetic poles of the rotor 32 is two. However, the number of magnetic poles of the rotor 32 is not limited to two, may be four, six, or more than six. The rotor 32 may be an inner rotor or an outer rotor. The number of slots of the stator 31 is not limited to three. In any case, the motor controller 21 performs, on the brushless motor 3, vector control (sensorless vector control) for estimating a position of magnetic poles and a rotational speed by using a control model based on a d-q-axis coordinate system.

It is noted that, in the following description, of a south pole and a north pole of the rotor 32, a rotational angular position of the north pole shown by a filled circle is sometimes referred to as a “position of magnetic pole PS” of the rotor 32.

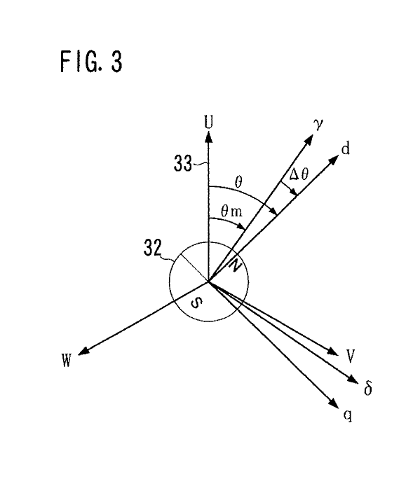

FIG. 3 shows an example of a d-q-axis model of the brushless motor 3. The vector control on the brushless motor 3 is simplified by converting the 3-phase alternating current flowing through the windings 33-35 of the brushless motor 3 to a direct current applied to a 2-phase winding which rotates in synchronism with a permanent magnet acting as the rotor 32.

Let the direction of magnetic flux (direction of a north pole) of the permanent magnet be a d-axis. Let the direction of movement from the d-axis by an electrical angle of π/2[rad] (90°) be a q-axis. The d-axis and the q-axis are model axes. The U-phase winding 33 is used as a reference and a movement angle of the d-axis with respect to the reference is defined as an angle θ. The angle θ represents an angular position (position PS) of a magnetic pole with respect to the U-phase winding 33. The d-q-axis coordinate system is at a position moved, by angle θ, from the reference, namely, the U-phase winding 33.

Since the brushless motor 3 is provided with no position sensor to detect an angular position (position of magnetic pole) of the rotor 32, the motor controller 21 needs to estimate a position PS of the magnetic poles of the rotor 32. A γ-axis is defined corresponding to an estimated angle θm which represents the estimated position of the magnetic pole. A δ-axis is defined as a position moved, by an electrical angle of π/2, from the γ-axis. The γ-δ axis coordinate system is positioned moved, by estimated angle θm, from the reference, namely, the U-phase winding 33. A delay of the estimated angle θm with respect to the angle θ is defined as an angle Δθ.

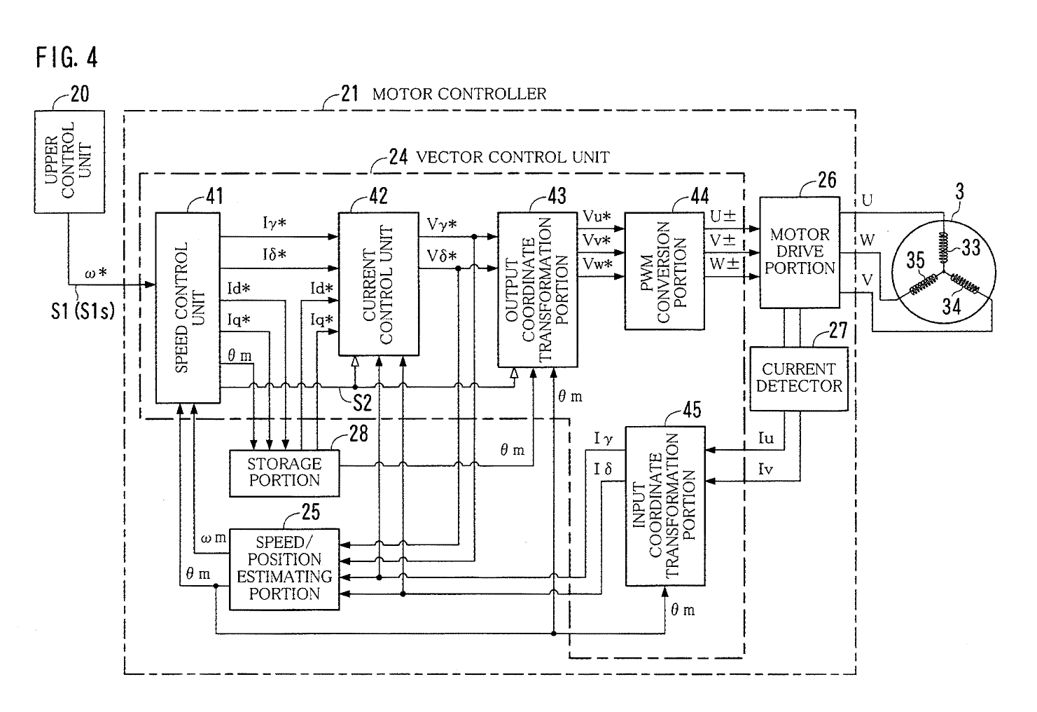

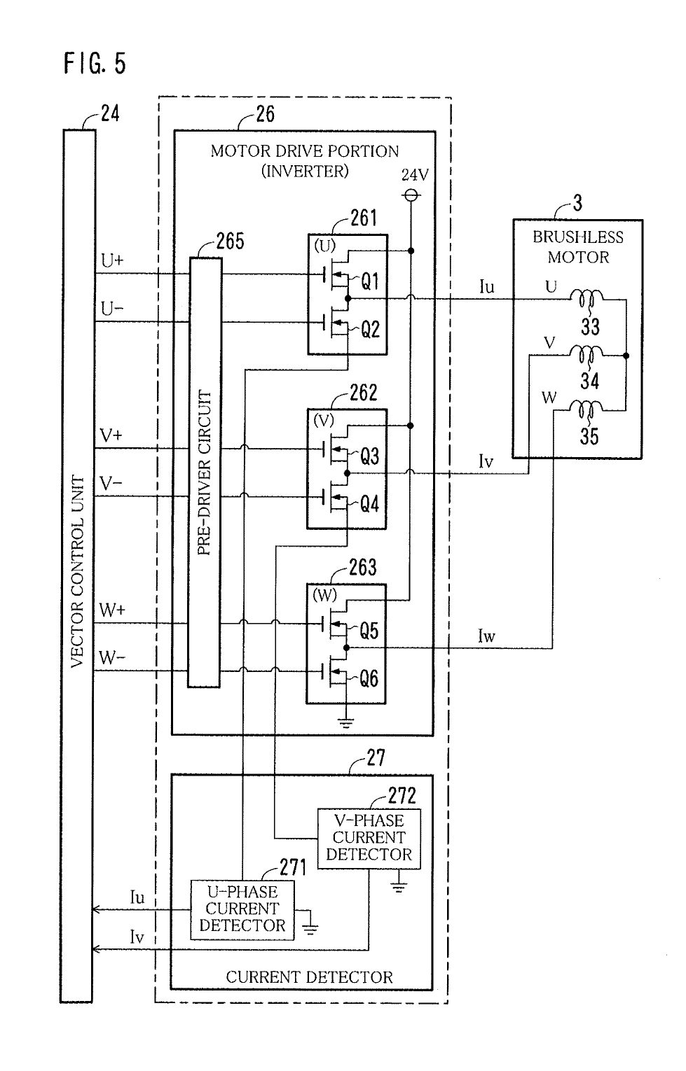

FIG. 4 shows an example of the functional configuration of the motor controller 21. FIG. 5 shows an example of the configuration of a motor drive portion 26 and a current detector 27 of the motor controller 21.

Referring to FIG. 4, the motor controller 21 includes the motor drive portion 26, the current detector 27, a vector control unit 24, a speed/position estimating portion 25, and a storage portion 28.

The motor drive portion 26 is an inverter circuit for supplying a current to the windings 33-35 of the brushless motor 3 to drive the rotor 32. Referring to FIG. 5, the motor drive portion 26 includes three dual elements 261, 262, and 263, and a pre-driver circuit 265.

Each of the dual elements 261-263 is a circuit component that packages therein two transistors having common characteristics (Field Effect Transistor: FET, for example) connected in series.

Transistors Q1 and Q2 of the dual element 261 control a current Iu flowing through the winding 33. The transistors Q3 and Q4 of the dual element 262 control a current Iv flowing through the winding 34. The transistors Q5 and Q6 of the dual element 263 control a current Iw flowing through the winding 35.

Referring to FIG. 5, the pre-driver circuit 265 converts control signals U+, U−, V+, V−, W+, and W− fed from the vector control unit 24 to voltage levels suitable for the transistors Q1-Q6. The control signals U+, U−, V+, V−, W+, and W− that have been subjected to the conversion are given to control terminals (gates) of the transistors Q1-Q6.

The current detector 27 includes a U-phase current detector 271 and a V-phase current detector 272 to detect currents Iu and Iv flowing through the windings 33 and 34, respectively. Since the relationship of Iu+Iv+Iw=0 is satisfied, the current Iw can be obtained from the calculation of the values of the currents Iu and Iv detected.

The U-phase current detector 271 and the V-phase current detector 272 amplify a voltage drop by a shunt resistor having a small value ( 1/10Ω order) of resistance provided in the current path of the currents Iu and Iv to perform A/D conversion on the resultant, and output the resultant as detection values of the currents Iu and Iv. In short, a two-shunt detection is made.

The motor controller 21 may be configured by using a circuit component in which the motor drive portion and the current detector 27 are integral with each other.

Referring back to FIG. 4, the vector control unit 24 controls the motor drive portion 26 in accordance with a speed command value ω* indicated in a speed command S1 given by a upper control unit 20. The upper control unit 20 is a controller to control an overall operation of the image forming apparatus 1. The upper control unit 20 gives the speed command S1 when: the image forming apparatus 1 warms up; the image forming apparatus 1 executes a print job; the image forming apparatus 1 turns into a power-saving mode; and so on. In instructing to stop driving the rotation, the upper control unit 20 gives the speed command S1 with the speed command value ω* set at “0 (zero)” to the vector control unit 24. In short, the speed command S1 for this case is a stop command S1s.

The vector control unit 24 controls the motor drive portion 26 to generate a rotating magnetic field based on the estimated position of magnetic poles. The vector control unit 24 also controls the motor drive portion 26 to stop the rotor 32 in response to the stop command S1s inputted.

The control to stop the rotor 32 by the vector control unit 24 is as follows. The vector control unit 24 determines a current to generate a magnetic field vector which draws the position of magnetic pole PS of the rotor 32 to the stop position to stop the rotor 32 based on the latest estimated position of magnetic pole PS, and controls the motor drive portion 26 to keep supplying the current determined through the windings 33-35. The details of the control is provided below.

The vector control unit 24 includes a speed control unit 41, a current control unit 42, an output coordinate transformation portion 43, a PWM conversion portion 44, and an input coordinate transformation portion 45. The individual portions perform the processing as discussed below when the speed command S1 given from the upper control unit 20 is not the stop command S1s, namely, when the estimated speed value ωm is not “0 (zero)”.

The speed control unit 41 determines current command values Iγ* and Iδ* of the γ-δ axis coordinate system based on the speed command value ω* fed from the upper control unit 20 and an estimated speed value ωm fed from the speed/position estimating portion 25 in such a manner that the estimated speed value ωm approaches the speed command value ω*.

The current control unit 42 determines voltage command values Vγ* and Vδ* of the γ-δ axis coordinate system based on the current command values Iγ* and Iδ*.

The output coordinate transformation portion 43 transforms the voltage command values Vγ* and Vδ* to a U-phase voltage command value Vu*, a V-phase voltage command value Vv*, and a W-phase voltage command value Vw* based on the estimated angle θm fed from the speed/position estimating portion 25.

The PWM conversion portion 44 generates control signals U+, U−, V+, V−, W+, and W− based on the voltage command values Vu*, Vv*, and Vw* to output the control signals U+, U−, V+, V−, W+, and W− to the motor drive portion 26. The control signals U+, U−, V+, V−, W+, and W− are signals to control, by Pulse Width Modulation (PWM), the frequency and amplitude of the 3-phase alternating power to be supplied to the brushless motor 3.

The input coordinate transformation portion 45 uses the values of the U-phase current Iu and the V-phase current Iv detected by the current detector 27 to calculate a value of the W-phase current Iw. The input coordinate transformation portion 45 then calculates estimated current values Iγ and Iδ of the γ-δ axis coordinate system based on the estimated angle θm fed from the speed/position estimating portion 25 and the values of the 3-phase currents Iu, Iv, and Iw. In short, the input coordinate transformation portion 45 transforms the 3-phase currents to the 2-phase currents.

The speed/position estimating portion 25 determines the estimated speed value ωm and an estimated angle θm in accordance with a so-called voltage current equation based on the estimated current values Iγ and Iδ fed from the input coordinate transformation portion 45 and the voltage command values Vγ* and Vδ* fed from the current control unit 42. The estimated speed value ωm is an example of an estimated value of the rotational speed of the rotor 32. The estimated angle θm is an example of an estimated value of the position of magnetic poles of the rotor 32. The estimated current values Iγ and Iδ are examples of values of the currents Iu and Iv detected by the current detector 27.

The estimated speed value ωm thus determined is inputted to the speed control unit 41. The estimated angle θm thus determined is inputted to the speed control unit 41, the output coordinate transformation portion 43, and the input coordinate transformation portion 45.

The individual portions of the vector control unit 24 and the speed/position estimating portion 25 control the motor drive portion 26 to drive the rotation of the brushless motor 3.

In the meantime, the motor controller 21 according to this embodiment has a function to stop the rotor 32 of the brushless motor 3 at a desired stop position. The description goes on to the details of the structure and operation of the motor controller 21, focusing on the function of the motor controller 21.

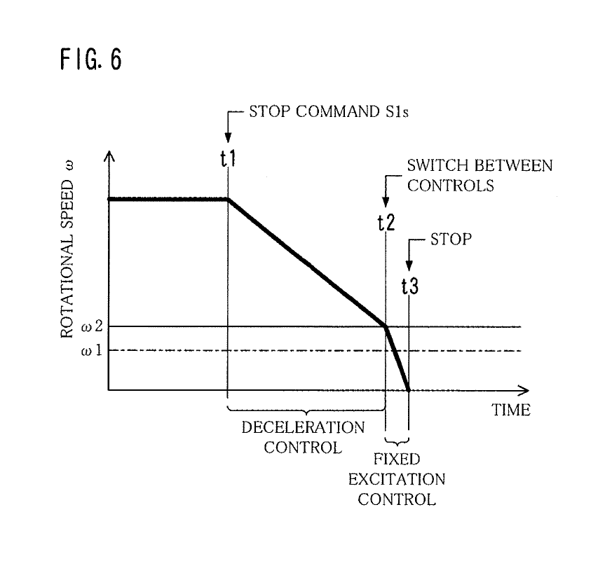

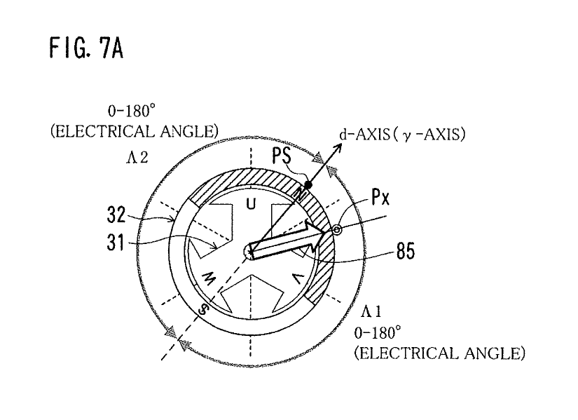

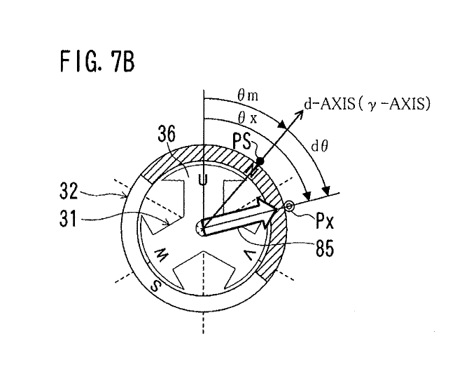

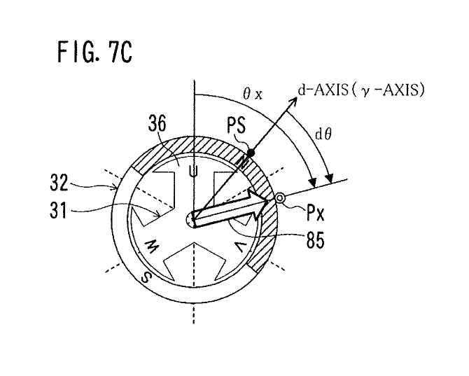

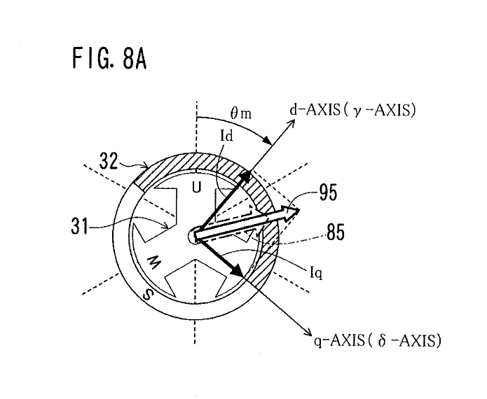

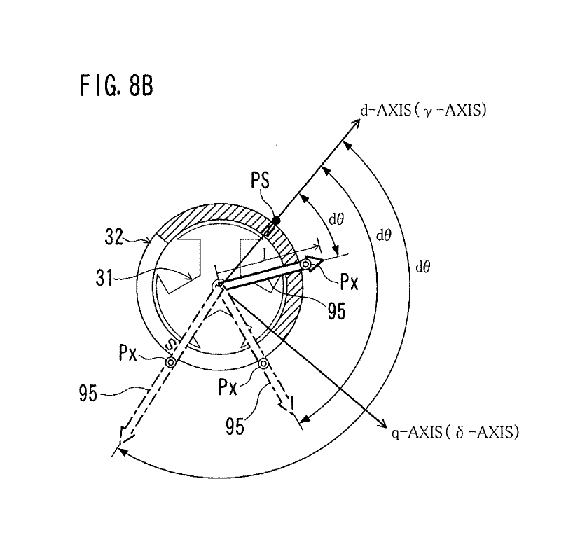

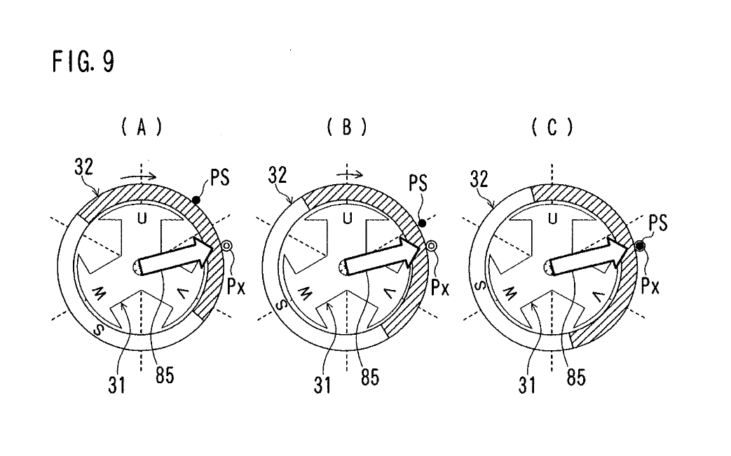

FIG. 6 shows an example of a drive sequence at the time of the stop. FIGS. 7A-7C show examples as to how to set a magnetic field vector 85 for stopping the rotor 32. FIGS. 8A and 8B show examples of current vectors 95 corresponding to the magnetic field vector 85. FIG. 9 shows examples of a state of the rotor 32 and the magnetic field vector 85 before the rotor stops by fixed excitation control.

Referring to FIG. 6, at a time t1, the upper control unit 20 inputs the stop command S1s to the motor controller 21. It is supposed that, before the time t1, the vector control is made and a rotational speed ω is kept at constant. The rotational speed ω may be, however, increased or reduced.

In response to the stop command S1s inputted, the motor controller 21 starts deceleration control. The deceleration control is, for example, to control the rotation (frequency) of the rotating magnetic field to gradually reduce the rotational speed ω. However, the control method is not limited to the deceleration control. A so-called 3-phase short brake control or a free running control may be performed. For the short brake control, all of the transistors Q1, Q3, and Q5 of the motor drive portion 26 are turned off and all of the transistors Q2, Q4, and Q6 are turned on. For the free running control, all of the transistors Q1-Q6 are turned off.

The deceleration control is continued until the rotational speed ω is decreased to a preset control switch speed ω2 which is equal to or greater than a lower limit speed ω1. The lower limit speed ω1 means the lowest rotational speed ω at which estimating the position of magnetic pole PS based on currents Iu and Iv by the speed/position estimating portion 25 is possible.

In response to the rotational speed ω decreased to the control switch speed ω2 (time t2), the motor controller 21 switches the control to be carried out from the deceleration control to the fixed excitation control.

The fixed excitation control is a control in which, in order to stop the rotor 32, a current is kept flowing through the windings 33-35 to generate a magnetic field for drawing the magnetic poles of the rotor 32 to predetermined stop positions. Referring to FIG. 6, the rotor 32 stops at a time t3.

The fixed excitation control involves using an estimated angle θm estimated by the speed/position estimating portion 25. For this reason, the control switch speed ω2 is so set that a time at which to switch from the deceleration control to the fixed excitation control falls within a period during which estimating by the speed/position estimating portion 25 is possible.

The fixed excitation control is detailed below.

Referring to FIGS. 7A-9, a stop position Px at which the rotor 32 is to be stopped, namely, a target position, is indicated by a double circle.

In FIGS. 7A-9, the d-axis representing a magnetic flux direction of a permanent magnet is almost the same as the γ-axis determined based on the estimated angle θm. Thus, the d-axis and the q-axis are treated as being equivalents to the γ-axis and the δ-axis, respectively. The d-axis and the q-axis are axes representing ideal magnetic flux directions of the permanent magnet. In practice, however, the γ-axis and the δ-axis are estimated or detected based on the estimated angle θm. Therefore, the γ-axis and the δ-axis may be used for actual control. In short, according to the present invention, γ-axis-δ-axis may be used instead of the d-q axis, and further, Iγ, Iδ, and θm may be used instead of Id, Iq, and θ, respectively.

When the control is switched to the fixed excitation control, as shown in FIG. 7A, the motor controller 21 defines the magnetic field vector 85 stretching from the center of the rotation of the rotor 32 to the stop position Px. The magnetic field vector 85 represents a magnetic field for drawing the rotor 32 to the stop position Px.

The stop position Px which defines the direction of the magnetic field vector 85 falls within ranges Λ1 and Λ2 of a different amount of 180° at maximum by electrical angle in each of a travel direction and a delay direction between the stop position Px and the position of magnetic pole PS. To be specific, the stop position Px is so set to be any position of the range Λ1 in which 0 through +180°, by electrical angle, is different from the position of magnetic pole PS in the travel direction. Alternatively, the stop position Px is so set to be any position of the range Λ2 in which 0 through −180°, by electrical angle, is different from the position of magnetic pole PS in the delay direction.

The number of poles of the brushless motor 3 shown herein is two and the electrical angle and the mechanical angle are equal to each other. The stop position Px, therefore, may be any position of a range in which 0 through ±180°, by mechanical angle, is different from the position of magnetic pole PS, in other words, may be any position of the circumference (range of 360°).

The stop position Px may be a relative position determined with respect to the position of magnetic pole PS at that time. Alternatively, the stop position Px may be one preset position (absolute position).

In the former case where the stop position Px is set at a relative position, an angle dθ between the position of magnetic pole PS and the stop position Px shown in FIG. 7B is determined in advance. The angle dθ is an angle within a range from −180° to +180°, by electrical angle, as discussed above. The stop position Px is identified as an angle θx, for example, between an angular position of the U-phase core 36 and the stop position Px. The angle θx corresponds to an angle of the sum of the estimated angle θm and the angle dθ.

In the latter case where the stop position Px is set at one preset position, an angle θx for identifying the stop position Px as shown in FIG. 7C is preset. In such a case, the angle dθ between the position of magnetic pole PS and the stop position Px changes depending on the position of magnetic pole PS.

In the meantime, setting the magnetic field vector 85 corresponds to setting the current vector 95 of which a direction is the same as that of the magnetic field vector 85 as shown in FIG. 8A. The current vector 95 represents a current to be passed through the windings 33-35 in order to generate a magnetic field which draws the rotor 32 to the stop position Px.

Setting the current vector 95 is to, in practical processing to control the motor drive portion 26, set the direction and magnitude of the current vector 95. As the direction of the current vector 95, the angle θm representing the angular position of the d-axis is set. As the magnitude of the current vector 95, a d-axis component Id and a q-axis component Ig of the current vector 95 are set.

As shown in FIG. 8B, the magnitude of the current vector 95 is so set to be greater as the angle dθ between the position of magnetic pole PS and the stop position Px is greater. Stated differently, the magnitude of the current vector 95 is so set that the position of magnetic pole PS is drawn to the stop position Px and stops so as to avoid: a situation where the position of magnetic pole PS does not reach the stop position Px; and a situation where the position of magnetic pole PS passes by the stop position Px and the rotation still continues.

For example, each of the ranges Λ1 and Λ2 shown in FIG. 7A may be divided into a plurality of angular ranges, and a value of the magnitude of the current vector 95 may be determined, for each of the angular ranges, based on the results of experiment or theoretical calculation. Values for the range Λ1 (values for the case where the rotor 32 is rotated in the same direction as the previous rotation and is drawn to the stop position Px) may be determined separately from values for the range Λ2 (values for the case where the rotor 32 is rotated in a direction opposite to the direction of the previous rotation and is drawn to the stop position Px). The values thus determined are gathered in a table and stored as data for controlling use.

Supposing that the magnitude of the current vector 95 is denoted by “I”, the d-axis component Id and the q-axis component Iq are expressed in the following equations.

Id=I×cos (dθ)

Id=I×sin (dθ)

The current vector 95 is set as discussed above and the motor drive portion 26 is controlled. The control makes the state of (A) of FIG. 9 transient to the state (B) of FIG. 9 and then to the state of (C) of FIG. 9. To be specific, the rotor 32 is rotated in a direction such that the position of magnetic pole PS approaches the stop position Px, and the rotor 32 stops at a time when the position of magnetic pole PS comes at the stop position Px. The rotor 32 is rotated; however, neither the direction nor the magnitude of the magnetic field vector 85 changes. Stated differently, the current applied to the windings 33-35 is constant and does not change.

After the current vector 95 is set, the vector control using the d-q axis model is not performed because estimating the estimated angle θm is not performed. Herein, however, a d-q coordinate system rotating synchronously with the rotation of the rotor 32 is supposed and it is supposed that the current applied to the windings 33-35 is a resultant current of a d-axis current and a q-axis current. In the supposition, it is probable that “the d-axis current increases from the initial value (value of the d-axis component Id set) as the position of magnetic pole PS approaches the stop position Px, and eventually reaches “I”. It can be said that “the q-axis current decreases from the initial value (value of the q-axis component Iq set) as the position of magnetic pole PS approaches the stop position Px, and eventually reaches 0 (zero)”.

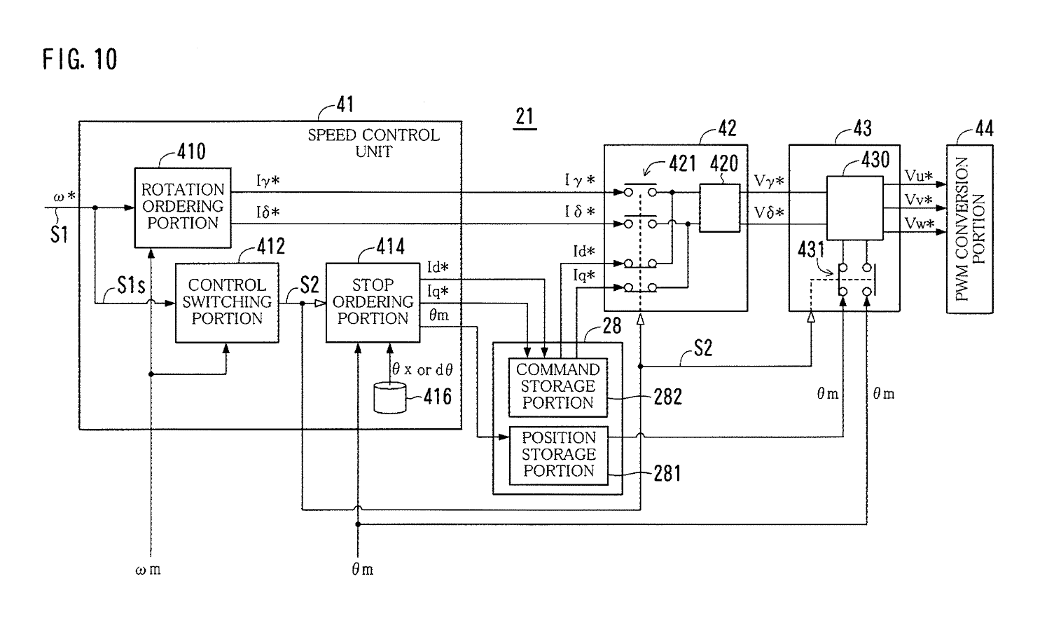

FIG. 10 shows an example of the configuration of the speed control unit 41, the storage portion 28, the current control unit 42, and the output coordinate transformation portion 43 of the motor controller 21.

Referring to FIG. 10, the speed control unit 41 is configured of a rotation ordering portion 410, a control switching portion 412, a stop ordering portion 414, a non-volatile memory 416, and so on. The control switching portion 412, the stop ordering portion 414, and the non-volatile memory 416 are involved in processing for stopping the brushless motor 3.

The rotation ordering portion 410 determines the current command values Iγ* and Iδ* based on the speed command value ω* and the estimated speed value on. In short, the rotation ordering portion 410 is involved in processing for driving the rotation of the brushless motor 3.

The control switching portion 412 switches the control by the motor controller 24 from the deceleration control to the fixed excitation control at a predetermined time after the upper stop command S1s is inputted from the control unit 20. The time to switch the control may be any point in time as long as the point is included in a period during which the rotor 32 can be stopped at the desired stop position Px by the fixed excitation control. As one example, the point in time is a point in time when the estimated speed value corn to be inputted as the rotational speed ω of the brushless motor 3 is reduced to the predetermined control switch speed ω2. As another example, the point in time is a point in time when a predetermined amount of time has elapsed since the stop command S1s was entered. As yet another example, the point in time is a point in time when estimating the position of magnetic pole PS becomes impossible as described later.

The control switching portion 412 switches the control, and outputs a fixed excitation mode signal S2 indicating that a mode to perform the fixed excitation control is entered. The fixed excitation mode signal S2 keeps being supplied to the stop ordering portion 414, the current control unit 42, and the output coordinate transformation portion 43 while the fixed excitation control is performed.

In response to the fixed excitation mode signal received, the stop ordering portion 414 obtains an angle dθ or an angle θx from the non-volatile memory 416, and obtains the latest estimated angle θm indicating the position of magnetic pole PS from the speed/position estimating portion 25 (see FIG. 4).

Where the stop position PS is set at a relative position, the stop ordering portion 414 determines the magnitude (I) of the current vector 95 in accordance with the obtained angle dθ, and calculates a d-axis component Id, a d-axis component Id of the q-axis component current vector 95, and a q-axis component Iq. The stop ordering portion 414 then stores, into the command storage portion 282 of the storage portion 28, the d-axis component Id and the q-axis component Iq as the current command value Id* and the current command value Iq*, respectively. The stop ordering portion 414 also stores, into the position storage portion 281 of the storage portion 28, the obtained estimated angle θm as information indicating the position of magnetic pole PS.

Where the stop position PS is set at a preset position, the stop ordering portion 414 calculates an angle dθ based on the obtained angle θx and the estimated angle θm. The stop ordering portion 414 determines the magnitude (I) of the current vector 95 in accordance with the angle dθ calculated, calculates the d-axis component Id and the q-axis component Iq of the current vector 95, and stores the same as the current command values Id* and Iq* into the command storage portion 282. The stop ordering portion 414 also stores the estimated angle θm obtained into the position storage portion 281.

The storage portion 28 stores the estimated angle θm, the current command value Id*, and the current command value Iq* until a new request for storing is received. The current command values Id* and Iq* stored in the command storage portion 282 are sent to the current control unit 42. The estimated angle θm stored in the position storage portion 281 is sent to the output coordinate transformation portion 43.

The current control unit 42 includes an input switching portion 421 and a conversion processing portion 420.

When no fixed excitation mode signal S2 is inputted, the input switching portion 421 sends, to the current/voltage conversion portion 420, the current command values Iγ* and Iδ* received from the speed control unit 41. In contrast, when the fixed excitation mode signal S2 is inputted, the input switching portion 421 sends, to the conversion processing portion 420, the current command values Id* and Iq* received from the command storage portion 282.

The conversion processing portion 420 determines voltage command values Vγ* and Vδ* based on the current command values Iγ* and Iδ* or the current command values Id* and Iq* received from the input switching portion 421. Since the current command values Id* and Iq* inputted remain constant in the fixed excitation control, the voltage command values Vγ* and Vδ* determined at the beginning are kept being outputted.

The output coordinate transformation portion 43 includes an input switching portion 431 and a 2-phase/3-phase conversion portion 430.

When no fixed excitation mode signal S2 is inputted, the input switching portion 431 sends the estimated angle θm received from the speed/position estimating portion 25 (FIG. 4) to the 2-phase/3-phase conversion portion 430. In contrast, when the fixed excitation mode signal S2 is inputted, the input switching portion 431 inputs an estimated angle θm received from the position storage portion 281 to the 2-phase/3-phase conversion portion 430.

The 2-phase/3-phase conversion portion 430 converts the voltage command values Vγ* and Vδ* into a U-phase voltage command value Vu*, a V-phase voltage command value Vv*, and a W-phase voltage command values Vw* based on the estimated angle θm received from the input switching portion 421. Since the voltage command values Vγ* and Vδ* inputted remain constant in the fixed excitation control, the voltage command values Vu*, Vv*, and Vw* determined at the beginning are kept being outputted.

According to the foregoing configuration, during the output of the fixed excitation mode signal S2, the 3-phase voltage command values Vu*, Vv*, and Vw* generated based on the current command values Id* and Iq* and the estimated angle θm are given to the PWM conversion portion 44. Since the current command values Id* and Iq* and the value of the estimated angle θm are kept at constant values, a constant amount of the current is supplied through the motor drive portion 26 to the windings 33-35 of the brushless motor 3. This enables the position of magnetic pole PS to be drawn to the stop position Px so that the rotor 32 stops as shown in FIG. 9.

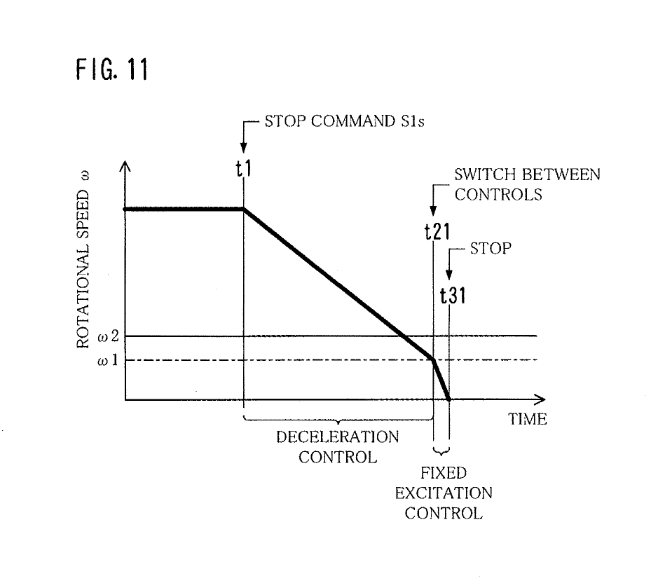

FIG. 11 shows another example of a drive sequence at the time of the stop.

According to the drive sequence shown in FIG. 6, the control is switched from the deceleration control to the fixed excitation control when the rotational speed ω is decreased to the control switch speed ω2. In the drive sequence shown in FIG. 11, the control is switched from the deceleration control to the fixed excitation control when estimating the position of magnetic pole PS and the rotational speed ω becomes impossible. The details thereof are provided below.

The deceleration control starts at the time t1 at which the stop command S1s is given. During the deceleration control, the current detector 27, the input coordinate transformation portion 45, and the speed/position estimating portion 25 obtain estimated angles θm at constant intervals. Where free running control is performed as the deceleration control, a short brake control is performed intermittently to detect currents Iu and Iv, and then to obtain the estimated angle θm.

If the estimated angle θm can be obtained, then the deceleration control continues. Unless the estimated angle θm is obtained, in other words, at a point in time t21 at which estimating the position of magnetic pole PS becomes impossible, the control on the brushless motor 3 is switched from the deceleration control to the fixed excitation control.

In the fixed excitation control, an estimated angle θm obtained the latest time before the control is switched to the fixed excitation control is used to obtain current command values Id* and Iq*. Processing other than this is the same as the drive sequence of FIG. 6. With the fixed excitation control, the rotor 32 stops at a time t31 of FIG. 11.

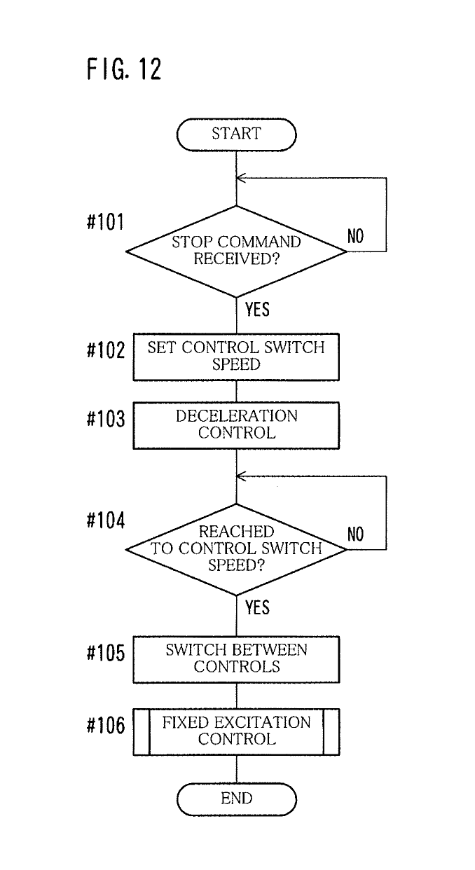

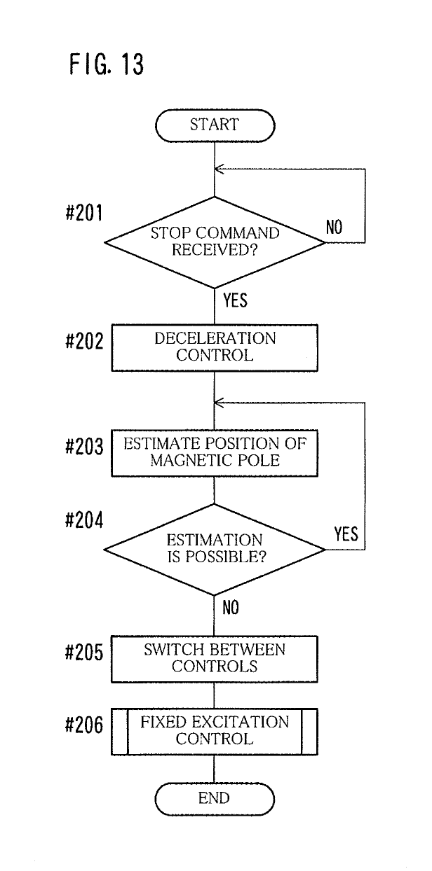

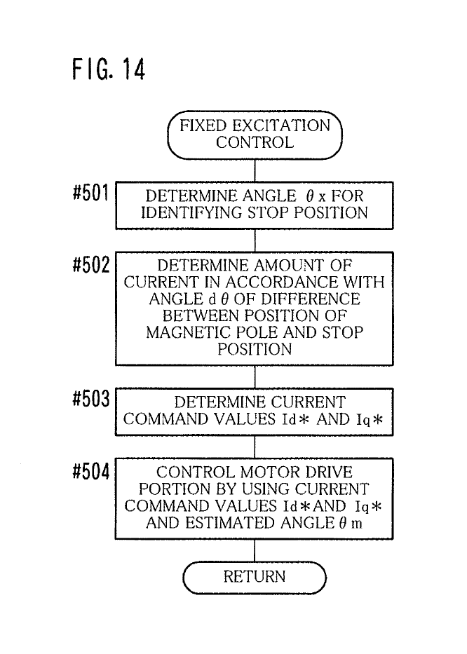

FIG. 12 shows an example of the flow of processing for stopping the rotation in the motor controller 24. FIG. 13 shows another example of the flow of processing for stopping the rotation in the motor controller 24. FIG. 14 shows an example of the flow of processing for fixed excitation control.

Referring to FIG. 12, the motor controller 24 waits for the stop command S1s to be received from the upper control unit 20 (Step #101). If the stop command S1s is received (YES in Step #101), then the control switch speed ω2 is set in a resistor for control use (Step #102), and then the deceleration control is started (Step #103).

If a rotational speed ω obtained as the estimated speed value ωm is decreased to a control switch speed ω2 (YES in Step #104), then the control is switched from the deceleration control to the fixed excitation control (Step #105). The fixed excitation control is performed to stop the rotation of the brushless motor 3 (Step #106).

Alternatively, the processing depicted in FIG. 13 is performed. To be specific, if the stop command S1s is received (YES in Step #201), then the deceleration control is started (Step #202). After that, estimating the position of magnetic pole PS is periodically performed (Steps #203 and #204). If estimating the position of magnetic pole PS becomes impossible (NO in Step #204), then the control is switched from the deceleration control to the fixed excitation control (Step #205). Then, the fixed excitation control is performed (Step #206).

Referring to FIG. 14, in the fixed excitation control, an angle θx for identifying the stop position Px is determined (Step #501). The magnitude (I) of the current vector 95 corresponding to an amount of current for excitation is determined based on an angle dθ of difference between the position of magnetic pole PS and the stop position Px (Step #502). A d-axis component Id and a q-axis component Iq of the current vector 95 are obtained to determine the current command values Id* and Iq* (Step #503).

The current command values Id* and Iq* and the estimated angle θm corresponding to the latest position of magnetic pole PS are used to generate control signals U+, U−, V+, V−, W+, and W−, and the control signals U+, U−, V+, V−, W+, and W− thus generated are given to the motor drive portion 26 (Step #504). In short, the motor drive portion 26 is so controlled that a current corresponding to the magnetic field vector 85 is supplied to the brushless motor 3.

In the foregoing embodiment, values of the currents of the U-phase, V-phase, and W-phase are set in an analog manner to generate a magnetic field for stopping the rotor 32. Thus, unlike a case where any of six patterns of magnetic fields determined based on combinations of ON, OFF, and direction of the currents of all the phases are generated, the stop position Px can be set variably. In other words, an amount of rotating angle can be set variably before the rotor stops due to the application of the magnetic field. In light of this, the rotor can stop in a stable manner so that an actual stop position comes at a target position. The rotor can also stop in a gentle manner so that little vibration occurs immediately before the rotor stops. Positioning the load can be made at a high degree of freedom so that the stop position can be determined carefully.

In the embodiment discussed above, it is possible to provide a controller and control method which stop a rotor of a permanent magnet synchronous motor at a desired position. For example, even when no position commands for designating rotational angular positions are given by the upper control unit 20 from moment to moment, the rotor can be stopped at a desired position.

According to the embodiment, the fixed excitation control is performed by using the control method with a control model by using, as the base, a d-q coordinate system in which a 3-phase alternating current is regarded as application of a direct current to a 2-phase winding. This makes the processing simple as compared with a case where other methods are used to calculate values of the 3-phase currents. A large part of structural elements used in the vector control for driving the rotation can also be used in the fixed excitation control. This simplifies the structure of the motor controller 21 as compared to the case where the use is not made.

In the foregoing embodiment, the current command values Id* and Iq* and the estimated angle θm are stored and the fixed excitation is made. The present invention is not, however, limited to this arrangement. Another arrangement is also possible in which a command value or a value of a control signal determined or generated based on the current command values Id* and Iq* and the estimated angle θm may be stored. To be specific, where the 2-phase voltage command values Vγ* and Vδ*, the 3-phase voltage command values Vu*, Vv*, and Vw*, or currents Iu, Iv, and Iw of the windings are stored, the motor drive portion 26 is so controlled to keep flowing the constant current through the windings 33-35, so that the rotor 32 can be stopped.

In the foregoing embodiment, even when a mechanical angle of the brushless motor 3 is smaller than an electrical angle thereof (when the number of magnetic poles is larger than 2), the rotor can be stopped by drawing a magnetic pole to a preset stop position Px (absolute position). Where a condition that the predetermined stop position Px falls within a range of ±180° by electrical angle with respect to the position of magnetic pole PS is satisfied, the control is preferably switched to the fixed excitation control. Stated differently, where the condition is not satisfied, switching to the fixed excitation control may be performed after the position of magnetic pole PS reaches a position at which the condition is satisfied. The determination as to whether or not the condition is satisfied may be performed at an appropriate time such as the time elapsed from the start of a deceleration control, so as to avoid reaching a speed for which estimating the position of magnetic pole PS becomes impossible before the condition is satisfied.

The position of magnetic pole PS is estimated based on values of the detected currents Iu and Iv in the foregoing embodiments. Instead of this, however, the position of magnetic pole PS may be estimated based on the frequency of currents Iu and Iv, values of voltages corresponding to the currents Iu and Iv, or frequency.

It is to be understood that the configuration of the image forming apparatus 1 and the motor controller 21, the constituent elements thereof, the content of the processing, the order of the processing, the time of the processing, and the like may be appropriately modified without departing from the spirit of the present invention.

Although embodiments of the present invention have been described and illustrated in detail, it is clearly understood that the same is by way of illustration and example only and not limitation, the scope of the present invention should be interpreted by terms of the appended claims.

What is claimed is:

1. A controller for a permanent magnet synchronous motor having a rotor using a permanent magnet, the rotor rotating by a rotating magnetic field caused by a current flowing through a winding, the controller comprising:
a drive portion configured to apply a current to the winding to drive the rotor;
an estimating portion configured to estimate a position of magnetic pole of the rotor based on the current flowing through the winding; and
a control unit configured to control the drive portion to cause the rotating magnetic field based on the estimated position of magnetic pole and to control the drive portion to stop the rotor in response to a stop command inputted; wherein
the control unit controls, as the control to stop the rotor, the drive portion to determine a current for generating a magnetic field vector which draws the position of magnetic pole of the rotor to a stop position to stop the rotor based on a latest estimated position of magnetic pole, and to keep applying the current determined to the winding.

2. The controller for the permanent magnet synchronous motor according to claim 1, wherein the stop position falls within a range of 180°, by electrical angle, in a delay direction and of 180°, by electrical angle, in a travel direction with respect to the latest position of magnetic pole.

3. The controller for the permanent magnet synchronous motor according to claim 1, wherein the control unit determines the current by using a d-axis component and a q-axis component of a current vector in a d-q coordinate system corresponding to the magnetic field vector at the stop position.

4. The controller for the permanent magnet synchronous motor according to claim 1, wherein
the control unit includes
a magnetic pole position storage portion configured to store, therein, the latest position of magnetic pole, and
a dq-axis component storage portion configured to store, therein, a d-axis component and a q-axis component of a current vector in a d-q coordinate system corresponding to the magnetic field vector at the stop position, and
the control unit controls the drive portion to keep applying the current to the winding by using the position of magnetic pole stored, the d-axis component stored, and the q-axis component stored.

5. The controller for the permanent magnet synchronous motor according to claim 3, wherein, in accordance with a difference between the latest position of magnetic pole and the stop position, the control unit makes the current vector larger as the difference is larger.

6. The controller for the permanent magnet synchronous motor according to claim 1, wherein
the estimating portion estimates the position of magnetic pole and estimates a rotational speed of the rotor based on a current flowing through the winding, and
in response to the stop command inputted, the control unit starts a deceleration control for decreasing the rotational speed on the drive portion, and, when the rotational speed estimated is decreased to a preset value, the control unit switches the control from the deceleration control to the control for stopping the rotor to control the drive portion.

7. An image forming apparatus comprising:
a permanent magnet synchronous motor having a rotor using a permanent magnet, the rotor rotating by a rotating magnetic field caused by a current flowing through a winding;
a controller configured to control the permanent magnet synchronous motor; and
a printer unit configured to form an image onto paper while feeding the paper by using a rotating member of which rotation is driven by the permanent magnet synchronous motor; wherein
the controller includes
a drive portion configured to apply a current to the winding to drive the rotor,
an estimating portion configured to estimate a position of magnetic pole of the rotor based on the current flowing through the winding, and
a control unit configured to control the drive portion to cause the rotating magnetic field based on the estimated position of magnetic pole and to control the drive portion to stop the rotor in response to a stop command inputted, and
the control unit controls, as the control to stop the rotor, the drive portion to determine a current for generating a magnetic field vector which draws the position of magnetic pole of the rotor to a stop position to stop the rotor based on a latest estimated position of magnetic pole, and to keep applying the current determined to the winding.

8. A method for controlling a permanent magnet synchronous motor having a rotor using a permanent magnet, the rotor rotating by a rotating magnetic field caused by a current flowing through a winding, the method comprising:
performing, as a control to stop the rotor, a fixed excitation control of determining a current to generate a magnetic field vector which draws a position of magnetic pole of the rotor to a stop position to stop the rotor based on the position of magnetic pole at that time and of keeping supplying the current determined to the winding.
